(19) United States
(12) Patent Application Publication
(10) Pub. No.: US 2005/0235910 A1
(43) Pub. Date: Oct. 27, 2005

(54) Coating apparatus with substrate cleaner

(75) Inventors: Chen Kun Teng, Miao-Li (TW); Ching-Lung Wang, Miao-Li (TW); Wen-Cheng Hsu, Miao-Li (TW); Yu-Ying Chan, Miao-Li (TW); Tseng-Kuei Tseng, Miao-Li (TW); Ho-Li Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/111,101

(22) Filed: Apr. 20, 2005

(30) Foreign Application Priority Data
Apr. 23, 2004 (TW) 93111374

(51) Int. Cl. B05C 5/00; B05C 15/00; B05B 7/00

(52) U.S. Cl. 118/302; 118/300; 118/323; 427/532

(57) ABSTRACT

A coating apparatus (20) for forming a photoresist film on a substrate (21) includes a flat table (30), a nozzle unit (40), and a particle cleaning unit (50). The flat table is used for supporting the substrate. The nozzle unit is used for dispensing photoresist material on a top surface of the substrate. The particle cleaning unit is used for removing particles from the top surface before the photoresist material is coated thereon. The coating apparatus can timely clean the substrate before coating. The coating performance is improved, and the nozzle unit is protected from being scratched or damaged.

### FIELD OF THE INVENTION

The present invention relates to coating apparatuses, and particularly to a coating apparatus for applications such as forming a photoresist film on a substrate.

### BACKGROUND

In the manufacturing of a liquid crystal display panel, a lithography process is often used for forming patterns on a component substrate. The substrate is commonly a glass substrate. The lithography process involves forming a photoresist film on the substrate. The forming of the photoresist film is carried out by coating a photoresist material on the substrate by use of a coating apparatus. The photoresist material generally comprises photoresist particles dissolved in a solvent.

Referring to FIG. 3, this shows a conventional coating apparatus 10 for forming a photoresist film on a substrate 13 by way of wiping. The coating apparatus 10 includes a flat table 16, a nozzle 11 used as a kind of dispenser cum wiper blade, a photoresist material supplying unit 12, and a nozzle rinser 15. The flat table 16 is used for supporting and holding the substrate 13 to be coated. The nozzle 11 is mounted on the flat table 16, and communicates with the photoresist material supplying unit 12 through a conduit (not labeled). Referring also to FIGS. 4 and 5, the nozzle 11 has a tapered slit portion at a bottom thereof. Thus the nozzle 11 can be steadily moved along a length of the substrate 13, while simultaneously dispensing photoresist material 14 onto the substrate 13 in the form of a continuous sheet. The nozzle rinser 15 is positioned at a left side of the flat table 16, and is used for rinsing and cleaning the nozzle 11.

FIG. 4 and FIG. 5 show operation of the coating apparatus 10. Firstly, the nozzle 11 is lowered to a predetermined position in which a distance between a bottom of the nozzle 11 and a top surface of the substrate 13 is equal to a thickness of the photoresist film to be coated. Secondly, photoresist material 14 is supplied from the photoresist material supplying unit 12 to the nozzle 11. The nozzle 11 is steadily moved from a first location A to a second location B, while simultaneously the nozzle 11 dispenses the photoresist material 14 onto the substrate 13. Thus, the photoresist material 14 is uniformly coated on the substrate 13 as the photoresist film.

However, the surroundings of the coating apparatus 10 may not be absolutely clean. If micro-particles in the surrounding environment settle on the substrate 13, the coating performance is reduced. In addition, the micro-particles may scratch or damage the nozzle 11.

What is needed, therefore, is a coating apparatus for coating a photoresist film on a substrate which can timely clean the substrate before coating.

### SUMMARY

A coating apparatus for forming a photoresist film on a glass substrate includes a flat table, a nozzle unit, and a particle cleaning unit. The flat table is used for supporting the substrate. The nozzle unit is used for dispensing photoresist material on a major surface of the substrate. The particle cleaning unit is used for removing particles from the major surface before the coating material is coated thereon. The coating apparatus can timely clean the glass substrate before coating. The coating performance is improved, and the nozzle unit is protected from being scratched or damaged.

Other objects, advantages, and novel features become more apparent from the following detailed description of a preferred embodiment when taken in conjunction with the accompanying drawings, in which:

### BRIEF DESCRIPTION OF THE DRAWINGS

FIG. 1 is an isometric view of a coating apparatus according to a preferred embodiment of the present invention, together with a substrate supported on the coating apparatus;

FIG. 2 is a schematic, side elevation of part of the coating apparatus and the substrate of FIG. 1, showing operation of the coating apparatus;

FIG. 3 is a schematic, side elevation of a conventional coating apparatus, together with a substrate supported on the coating apparatus;

FIG. 4 is similar to FIG. 3, but showing an operation of the coating apparatus coating photoresist material on the substrate; and

FIG. 5 is a top elevation of the substrate of FIG. 4 partly coated with photoresist material.

### DETAILED DESCRIPTION OF PREFERRED EMBODIMENT

Reference will now be made to the drawings to describe a preferred embodiment of the present invention in detail.

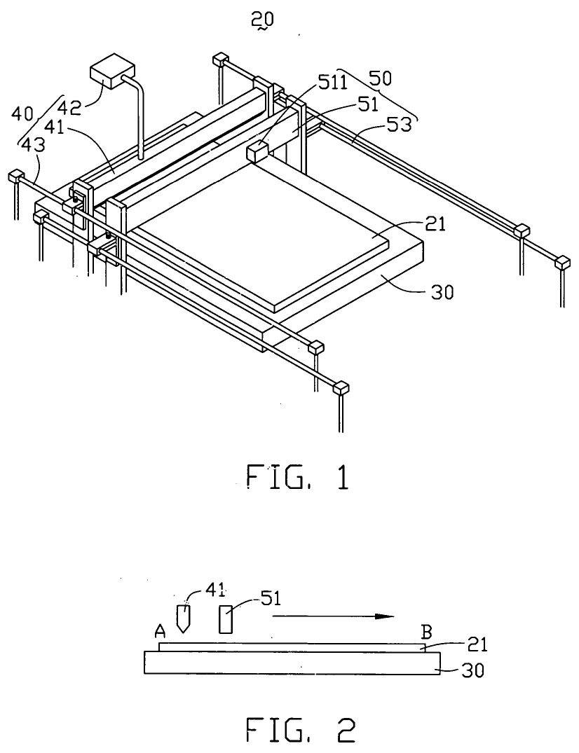

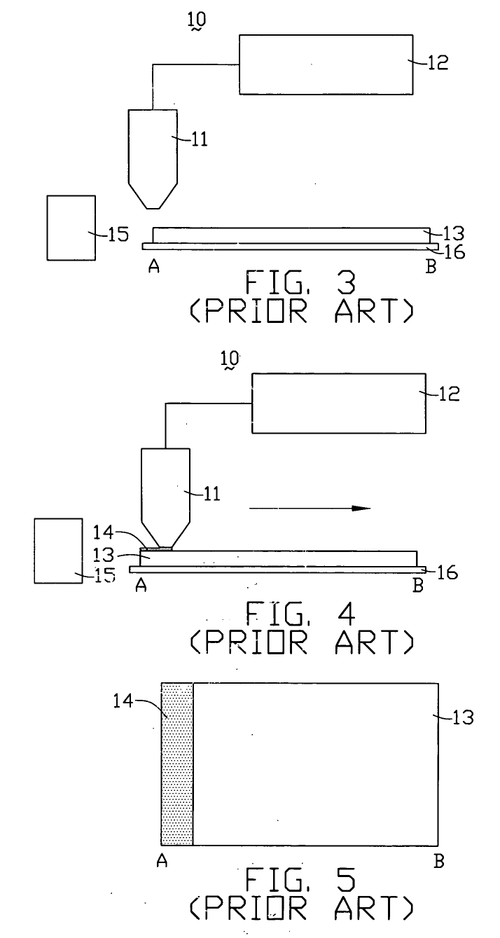

Referring to FIG. 1, a coating apparatus 20 for forming a photoresist film on a substrate 21 in accordance with a preferred embodiment of the present invention includes a flat table 30, a nozzle rinser (not shown), a nozzle unit 40, and a particle cleaning unit 50.

The flat table 30 can support and hold the substrate 21 to be coated by way of vacuum absorption way. The nozzle rinser is positioned at a side of the flat table 30, and is used for rinsing and cleaning a slit nozzle 41 of the nozzle unit 40.

The nozzle unit 40 includes the slit nozzle 41, a photoresist material supplying unit 42, a pair of first supporting frames 43, and a first driver (not shown). The first supporting frames 43 are positioned at two opposite long sides of the flat table 30, respectively. Two opposite ends of the slit nozzle 41 are engaged with the first supporting frames 43 respectively. Thus, the slit nozzle 41 is suspended over the flat table 30. The photoresist material supplying unit 42 communicates with the slit nozzle 41 through a pipe (not labeled), so as to supply photoresist material to the slit nozzle 41. The first driver can drive the slit nozzle 41 to move back and forth along a linear path defined perpendicular to and between the first supporting frames 43. Thus, the slit nozzle 41 can also function as a kind of wiper blade.

The particle cleaning unit 50 includes a particle cleaner 51, and pair of second supporting frames 53. The second supporting frames 53 are positioned at the two opposite long sides of the flat table 30 respectively, parallel with the first supporting frames 53. Two opposite ends of the particle cleaner 51 are engaged with the second supporting frames 53 respectively. Thus, the particle cleaner 51 is suspended over the flat table 30, and is set at a right side of the slit nozzle 41. The particle cleaner 51 can be, for example, an ultrasonic vacuum ultrasonic (UVU) system. The UVU system utilizes ultrasonic waves to vibrate particles, and utilizes a vacuum to take in the particles. The particle cleaner 51 includes a switch 511, and a second driver (not shown). Switching on and off of the particle cleaner 51 can be controlled by the switch 511. The second driver can drive the particle cleaner 51 to move back and forth along a linear path defined perpendicular to and between the second supporting frames 53.

Referring to FIG. 2, this shows operation of the coating apparatus 20. Firstly, the particle cleaner 51 is switched on, and moved from a first location A to a second location B. Thus, particles on the substrate 21 are cleaned off by the particle cleaner 51. Secondly, photoresist material is supplied from the photoresist material supplying unit 42 to the slit nozzle 41. The slit nozzle 41 is steadily moved from the first location A to the second location B, while simultaneously the slit nozzle 41 dispenses the photoresist material. Thus, the photoresist material is uniformly coated on the substrate 21 as a photoresist film.

The particle cleaner 51 of the coating apparatus 20 can remove particles from the substrate 21 before the photoresist material is coated on the substrate 21. Therefore the coating performance is improved. In addition, the slit nozzle 41 is protected from scratching or damage.

It is to be understood, however, that even though numerous characteristics and advantages of the preferred embodiment have been set forth in the foregoing description, together with details of the structure and function of the preferred embodiment, the disclosure is illustrative only, and changes may be made in detail, especially in matters of shape, size and arrangement of parts within the principles of the invention to the full extent indicated by the broad general meaning of the terms in which the appended claims are expressed.

1. A coating apparatus, comprising:
a table for supporting a substrate;
a nozzle unit for dispensing coating material on a major surface of the substrate; and
a particle cleaning unit for removing particles from the major surface before the coating material is coated thereon.

2. The coating apparatus as recited in claim 1, wherein the particle cleaning unit comprises a particle cleaner mounted on the table.

3. The coating apparatus as recited in claim 2, wherein the particle cleaner is an ultrasonic-vacuum-ultrasonic device.

4. The coating apparatus as recited in claim 3, wherein the ultrasonic-vacuum-ultrasonic device comprises a switch used to control switching on and off of the ultrasonic-vacuum-ultrasonic device.

5. The coating apparatus as recited in claim 4, wherein the particle cleaning unit further comprises a first frame, and the ultrasonic-vacuum-ultrasonic system is movably mounted on the first frame.

6. The coating apparatus as recited in claim 5, wherein the ultrasonic-vacuum-ultrasonic system further comprises a first driver, and the first driver can drive the ultrasonic-vacuum-ultrasonic system to move back and forth along a path defined by the first frame.

7. The coating apparatus as recited in claim 1, wherein the nozzle unit comprises a nozzle and a coating material supplying unit connecting with the nozzle, and the nozzle is mounted above the table.

8. The coating apparatus as recited in claim 7, wherein the nozzle unit further comprises a second frame, and the nozzle is movably mounted on the second frame.

9. The coating apparatus as recited in claim 8, wherein the nozzle unit further comprises a second driver, and the second driver can drive the nozzle to move back and forth along a path defined by the second frame.

10. The coating apparatus as recited in claim 2, wherein the particle cleaner comprises a switch used to control the switching on and off of the particle cleaner.

11. The coating apparatus as recited in claim 10, wherein the particle cleaning unit further comprises a first frame, and the particle cleaner is movably mounted on the first frame.

12. The coating apparatus as recited in claim 11, wherein the particle cleaner further comprises a first driver, and the first driver can drive the particle cleaner to move back and forth along a path defined by the first frame.

13. A coating apparatus, comprising:
a table for supporting a substrate;
a nozzle unit for dispensing coating material on a major surface of the substrate; and
a particle cleaning unit for removing particles from the major surface spaced from the nozzle unit in a first direction which is opposite to a second direction along which a relative movement of said substrate with regard to the nozzle unit and the particle cleaning unit directs.

14. A method of coating a substrate, comprising the steps of:
disposing a substrate upon a working table;
providing a nozzle unit for dispensing coating material on a major surface of the substrate; and
providing a particle cleaning unit for removing particles from the major surface before the coating material is coated thereon.

15. The method as claimed in claim 14, wherein said particle cleaning unit is located on one side of the nozzle unit in a direction which is opposite to another direction along which a relative movement of the substrate with regard to the nozzle unit and the particle cleaning unit directs.
